(19) United States
(12) Patent Application Publication
(10) Pub. No.: US 2005/0265529 A1
(43) Pub. Date: Dec. 1, 2005

(54) Switching call types in real-time

(76) Inventors: John S. Hogg JR., Bedford, TX (US); John C. Poss, New Braunfels, TX (US); Lisa Luker Ferner, Grapevine, TX (US); Nancy Kay Lee, Coppell, TX (US)

Correspondence Address: FENWICK & WEST LLP, SILICON VALLEY CENTER, 801 CALIFORNIA STREET, MOUNTAIN VIEW, CA, 94041, US

(21) Appl. No.: 11/078,594

(22) Filed: Mar. 11, 2005

Related U.S. Application Data
(60) Provisional application No. 60/552,461, filed on Mar. 11, 2004.

(51) Int. Cl. H04M 15/00

(52) U.S. Cl. 379/114.2; 379/114.01; 379/114.21

(57) ABSTRACT

A system is disclosed to establish a telephone connection between parties. In one embodiment, a system includes receives a request to validate an outbound call from a first party to a telephone number associated with a second party. The system determines whether the outbound call is permitted to the telephone number and whether a pre-established account exists to debit against call. In response to the pre-established account existing, the system switches the collect call to a prepaid platform. Alternatively, in response to the pre-established account not existing or the pre-established account having insufficient credit to debit against the call, the system places an inquiry call to the second party. In response to the inquiry call, the system creates for the second party an account to debit against the call. A method for the same is also disclosed.

### CROSS REFERENCE TO RELATED APPLICATIONS

This application claims priority under 35 USC § 119(e) to U.S. Provisional Patent Application No. 60/552,461, titled “Switching Call Types in Real-Time”, the contents of which are herein incorporated by reference.

### BACKGROUND OF THE INVENTION

1. Field of the Invention

The present invention generally relates to the field of telecommunications, and more specifically, to a system for switching call types in real-time in a telecommunications system.

2. Description of the Related Art

Conventional calling systems for use in environments such as correctional facilities (or prisons) are configured to validate calls place from an inmate (the calling party) to a person outside the facility (the called party). A basic validation system includes a review of where the calling party is located to determine what correctional facility the call is originating from and where the calling party is calling to determine if the inmate is permitted to place a call to the particular called party.

More advanced validation systems are also configured to ensure that an entity providing calling services at the correctional facility can get paid for calls made by inmates. To achieve this, some validation systems are configured to allow an inmate to place collect calls to a called party. However, a problem with this approach is that an inmate may not be permitted to place a collect call to certain dialed numbers, for example, a restricted number such as a pay phone. Another problem with this approach is that a telecommunications carrier may restrict calls placed on their system if no prior billing agreement between the carrier and one of the calling parties or the carrier and the telecommunications provider at the correctional facility is in place to ensure payment of the collect call.

To help address issues involving collect calls, some conventional validation systems have been configured to allow an inmate to establish a calling account at the correctional facility to which outbound calls can be billed. Typically, such accounts can be set up by the inmate through a correctional facility commissary in which the inmate makes deposits from received funds, for example, through inmate job wages or monies received from family and friends. Moreover, the validation system can be configured to allow an inmate to select between placing a collect call and placing a call through the calling account so that an inmate can actively manage how the funds in the calling account are applied.

Nevertheless, a problem with such conventional inmate initiated calling accounts is that in inmate must actively manage their account to ensure sufficient funds remain available in the account to apply against calls they seek to place. If there is an insufficient amount in the account the inmate would be unable to make calls to those outside the facility, e.g., family members or friends, until funds again become available to deposit against their account. Further, the inmate may be further inconvenienced by the limited time period in which deposits can be made to their account, e.g., during commissary operating hours, which may further impede the ability to make calls to outside the facility.

Therefore, from the above, there is a need for a system and process to allow for enhancing validation operations and providing operational flexibility for making calls between parties while ensuring that mechanisms can be implemented to help ensure appropriate credit (or payment) to the various parties involved in call placements as well as switching calls from one type (e.g., collect) to another type (e.g., prepaid) in real time. There is also a need to allow a telecommunications system handling a call to remain in complete control of the call, including, call duration, call placement (e.g., who the calling party is permitted to call), call time (e.g., when calls may be placed), and recording of calls.

### SUMMARY OF THE INVENTION

The present invention includes a system and a method for switching calls in real-time in response to a creating or replenishing an account to establish a telephone connection between a first party and a second party. In one embodiment a request is received to validate a collect call from a first party to a telephone number associated with the second party. The system (or method) then determines whether the collect call is permitted to the telephone number and whether a pre-established account exists to debit against the collect call to the telephone number.

The system, in response to the existence of a pre-established account, switches the collect call to a prepaid account subsystem (or platform or method) in real-time. In switching to the prepaid platform, the collect call is converted to a prepaid call. The prepaid subsystem receives an account number and telephone number to verify the availability of credit to apply against the call placed to the telephone number. The prepaid subsystem connects the call in response to credit being verified as available or disconnects the call in response to the credit being verified as unavailable.

If a pre-established account does not exist or does exist, but has insufficient credit to debit against the call, the system places an inquiry call to the second party. In response to the inquiry call, the system is configured to allow the second party to create a prepaid account to debit against collect calls.

The present invention provides a number of benefits and advantages. For example, the system allows for greater financial return on calls placed because of the ability to ensure that collect calls can be billed. Moreover, by providing an opportunity for a called party to set up a prepaid account relative to a calling party, the system is able to be credited for billed call, resulting in less financial loss from such collect calls.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 illustrates one embodiment of a telecommunications system with a centralized prepaid subsystem (or platform) using a validation engine in accordance with the present invention.

FIG. 2 is a flow chart that illustrates one embodiment of a call routing process in accordance with the present invention.

FIG. 3 is a flow chart that illustrates one embodiment of validation processing in accordance with the present invention.

FIG. 4 is a flow chart that illustrates one embodiment of prepaid switch (or subsystem) processing in accordance with the present invention.

FIG. 5 is a flow chart that illustrates one embodiment of prepaid call validation in accordance with the present invention.

FIG. 6 is a flow chart that illustrates one embodiment of collect call validation in accordance with the present invention.

FIG. 7 is a flow chart that illustrates one embodiment of a prepaid account set up in response to queue outbound call processing in accordance with the present invention.

### DETAILED DESCRIPTION OF THE PREFERRED EMBODIMENTS

The Figures (“FIG.”) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The present invention includes a system and a process for switching call processing from one call processing type, e.g., collect call, to another call processing type, e.g., pre-paid calling, in real time without requiring selection or input from a calling party. The present invention beneficially allows a called party to create a pre-paid account that can include credits to apply against call charges incurred from calls placed by a calling party. It is noted for ease of discussion that the called party may also be referenced as an A-party and is the party that initiates (or places) a call. Similarly, the called party may be referenced as a B-party and is the party that receives the call from the calling party.

In addition, it is noted that for ease of discussion the present system is described in the context of a telecommunication system installed at a correctional facility. The correctional facility may also be referenced as an inmate facility or a prison. It is also noted that the principles disclosed herein may also be applicable to environments in which there may be call restrictions, e.g., dormitories, hostiles, high security institutions, and the like.

Architectural Overview

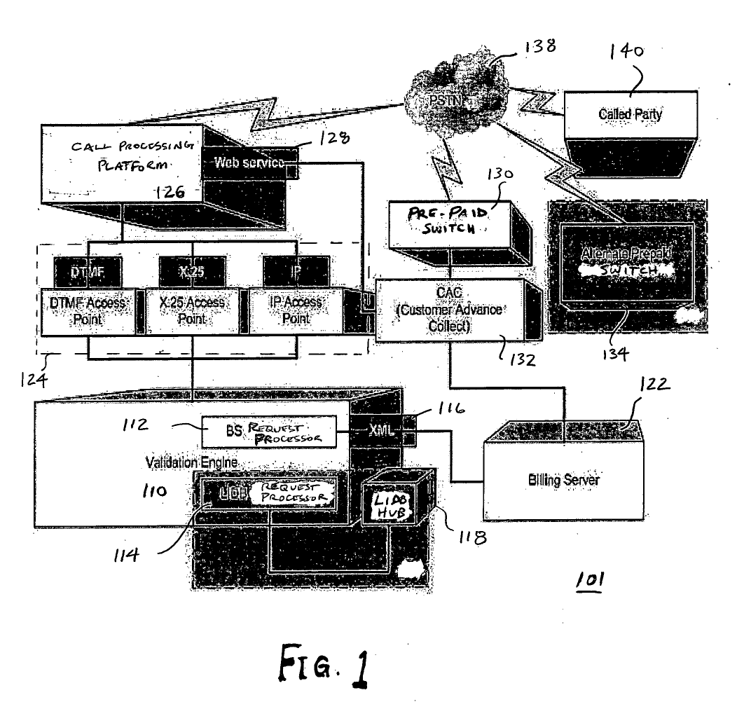

Referring now to FIG. 1, it illustrates one embodiment of a telecommunication system 101 that incorporates a centralized prepaid subsystem (or platform) and a validation engine in accordance with the present invention. The illustrated telecommunication system 101 includes a validation engine 110, a line information database (LIDB) hub 118, e.g., from a telephone company such SNET, a communication media 124, a premise based system (or calling platform) 126, a prepaid switch 130, and a customer advance collect (CAC) subsystem 132. A billing server 122 and an optional alternate prepaid switch 134 may also couple the telecommunication system 101. In addition, a called party 140 couples the telecommunication system through a voice communication system, e.g., a public switched telephone network (PSTN) 138.

The validation engine 110 and the call processing platform 126 are communicatively coupled through one or more communication media 124, e.g., dual tone multi frequency (DTMF), X.25, Internet Protocol (IP), or the like, through an appropriate access point. The premise base system (or calling platform) 126 communicates with the validation engine to obtain validation on whether a particular telephone call from a calling party (or A-party (e.g., an inmate)) is permitted (or connected) with the called party 140 (or B-party (e.g., a person outside the prison)). An example of a call processing platform 126 is a T-NETIX Inmate Calling System (ICS) made by T-NETIX, Inc. of Carrollton, Tex. or Evercom Call Applications Manager (CAM) System by Evercom Systems, Inc. or Irving, Tex.

As noted, the validation engine 110 is configured to validate whether the telephone call placed within the call processing platform 126 by the called party can be completed with the called party 140. For this, the validation engine 110 includes a LIDB request processor 114 that interfaces with the LIDB hub 118, whose function includes determining whether the call to the called party 140 is a bona fide (or allowed) telephone number to dial or whether that number is restricted. The validation engine 110 also includes a billing server request processor 112 that interfaces with a billing server 122 through an interface, e.g., an XML interface 116, which allows for the call to be billed to the appropriate party.

The call processing platform 126 and the billing server 122 are also communicatively coupled with the customer advanced collect 132 (e.g., through a web services interface). The customer advanced collect 132 also couples with the pre-paid switch 130. The pre-paid switch 130 is configured as a pre-arranged telephone credit account (e.g., cash account, credit card account, debit account, or the like) that is created and maintained by the called party 140. The prepaid switch is also configured to handle call routing and debiting functionality relating to charges applied against such accounts. The customer advanced collect 132 is also configured as a pre-arranged telephone credit account created and maintained by the calling party to make collect calls through the call processing platform 126. It is noted that the telecommunication system 101 can also be configured to include alternate pre-paid switches 134 in addition to the primary pre-paid switch 130.

System Processing and Operation

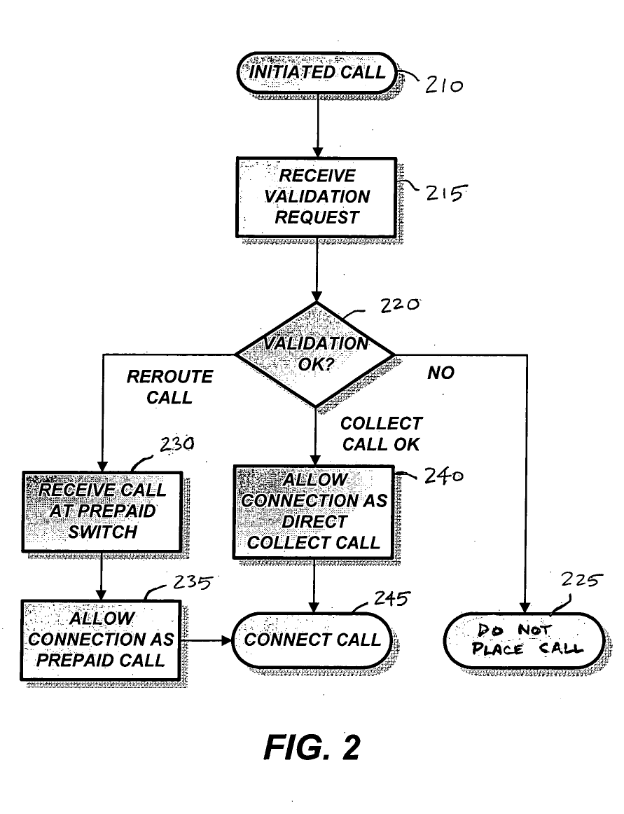

To further illustrate operation of the telecommunication system 101, FIGS. 2 through 7 illustrate processes for initiating, validating, and switching between call types in accordance with the present invention. The Figures will be described using an example in the context of a collect call made from a calling party using the call processing platform 126 to a called party 140.

FIG. 2 is a flow chart that illustrates one embodiment of a call routing process within the telecommunication system 101 in accordance with the present invention. In this example embodiment, call routing process begins with initiation 210 of a collect call by the calling party (e.g., the A-party or the inmate) to a telephone number associated with the called party 140 through the call processing platform 126. The process receives 215, e.g., at the validation engine 110, a validation request and determines 220 if whether the validation is “ok.”

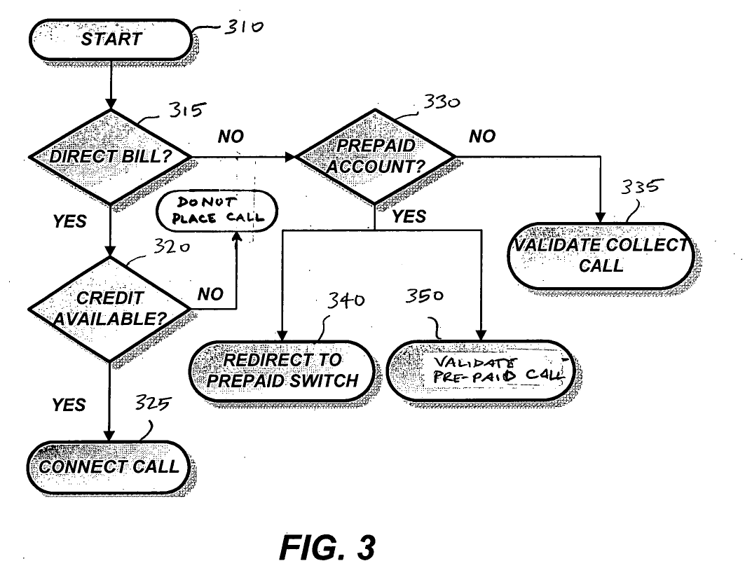

One embodiment of the validation processing (e.g., through the validation engine 110) is further described with respect to FIG. 3, but an overview is also provided with respect to FIG. 2. In particular, if the validation decision comes back as the collect call is not validated, e.g., the dialed telephone number matches a number that the calling party is not permitted to place a call to, the call is not placed 225. Non-placement of the call may include, for example, disconnecting the call and/or reporting the call to appropriate reporting entities.

If the collect call is validated as permitted, the process allows 240 connection of the collect call as a direct collect call and connects 245 the call through the PSTN 138. In such configurations, the call processing platform 126 may be configured to take into account any pre-arranged contractual relationship that may exist with a carrier through which the collect call is placed such that the call can be billed by the carrier.

If the validation decision 220 returns instructions to reroute the call, the process switches the call to the prepaid switch 130. The prepaid switch performs an analysis to determine if there is a sufficient balance for a prepaid call. If there is a sufficient balance available for a prepaid call, the prepaid switch allows 235 the call to connect as a prepaid call. The call is then connected 245 as a prepaid call.

FIG. 3 is a flow chart that illustrates one embodiment of validation processing in accordance with the present invention. The process starts 310 and determines 315 whether the collect call be directly billed. If the collect call can be directly billed to the calling party, the process determines 320 whether credit is available for the calling party to make the call against their account credit. If so, the process connects 325 the call. If the process determines that there is insufficient credit against which the collect call can be credited, the call will not be placed (e.g., disconnected). It is noted that in alternative embodiments, if there are insufficient funds, the process can be configured to allow a user to create a prepaid type account as further described herein.

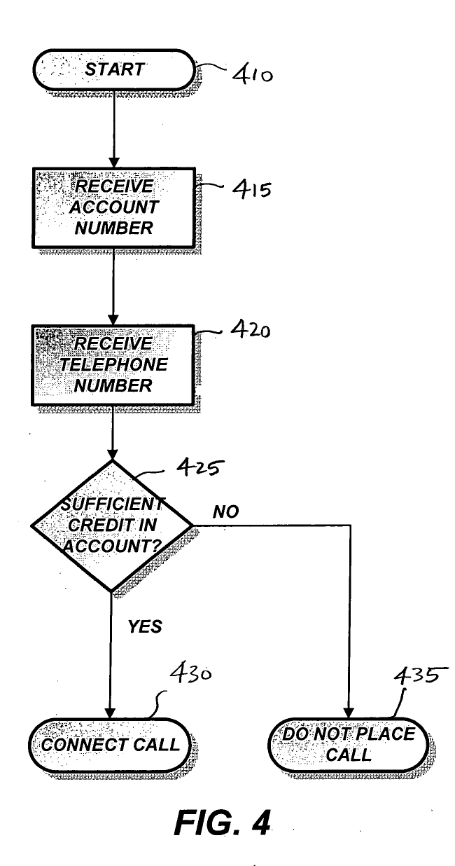

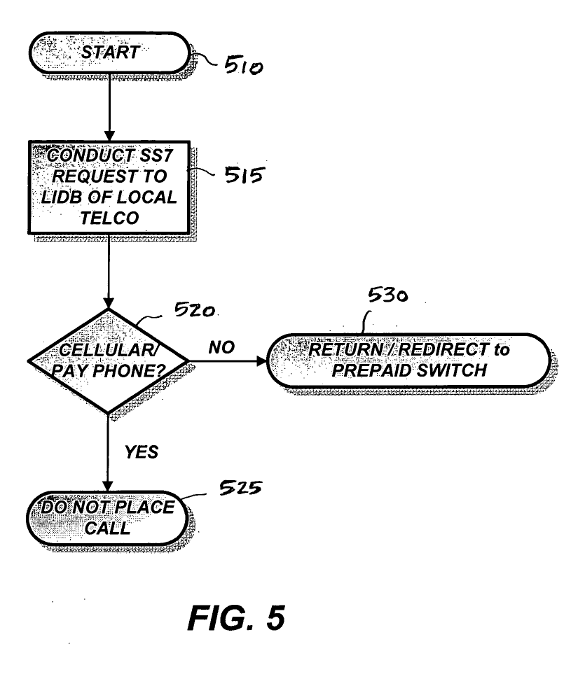

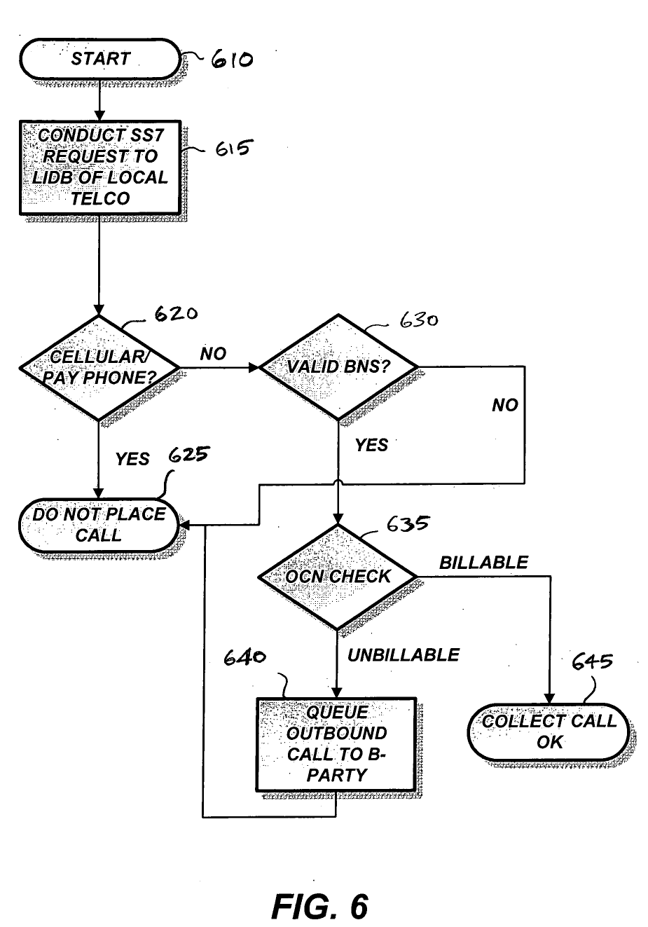

If the collect call cannot be directly billed, the process determines 330 whether there is a pre-paid account to which the collect call can be switched to a pre-paid call. If there is no prepaid account, the process will attempt to validate 335 the collect call as further describe below with respect to FIG. 6. If the process determines that the call is a prepaid account, the process either redirects 340 the call to a prepaid switch 130 as further described below with respect to FIG. 4 or prepares to validate 350 the prepaid call as further described below with respect to FIG. 5.

FIG. 4 is a flow chart that illustrates one embodiment of prepaid subsystem processing in, e.g., a prepaid switch 130, in accordance with the present invention in which a call. The process starts 410 and receives 415 an account number. The account number may be verified as being a valid account number and should be an account number against which the prepaid call can be appropriately billed. The process also receives 420 the telephone number the calling party is attempting to dial that would be billed as the prepaid call. It is noted that the account number and the telephone number can be received simultaneously or serially in either order.

Next, the process determines 425 whether there is a sufficient balance in the account. A sufficient balance may include having sufficient funds available or credited to the account against which charges associated with a call to the telephone number can be billed, e.g., debited. If there are sufficient funds in the prepaid account, the call is switched to a prepaid call and connected 420 with the called party. If there are insufficient funds in the prepaid account, the call is not placed 435 (e.g., disconnected and/or reported that call cannot be placed due to insufficient credit in the account).

In some embodiments where a prepaid account exists, the system may allow additional processing as a part of validation processing. FIG. 5 is a flow chart that illustrates one embodiment of prepaid call validation in accordance with the present invention.

The process starts 510 and the LIDB request processor 114 of the validation engine 110 conducts a signaling system 7 (SS7) request to the LIDB 118 of a local telephone company operator (e.g., SNET). An SS7 request allows telephone company computers to communicate with each other, making telephone call processing faster and more efficient to enable more services to be made available for users of a system (e.g., consumers). In this particular example, the SS7 request determines 515 whether the telephone number the calling party is attempting to connect with is a cellular phone or a pay phone. If yes, the system does not place the call (e.g., disconnects call and/or reports attempted call to a number the calling party is not permitted to call). If the call is not to a cellular phone or a pay phone, the process returns and redirects 530 the call to the prepaid switch 130 for prepaid switch processing.

FIG. 6 is a flow chart that illustrates one embodiment of collect call validation in accordance with the present invention. The process starts 610 with the LIDB request processor 114 of the validation engine 110 conducting an SS7 request to the LIDB 118 of the local telephone company. The process determines 620 whether the telephone number the calling party is attempting to call is a cellular phone or a pay phone. If it is, the call is not placed 625.

If the call is not to a cellular phone or pay phone telephone number, the process determines 630 if it is a valid billed number screening (BNS) code. The BNS code is a telephone network service that provides the capability of restricting collect and/or third number billing to telephone numbers, e.g., calls to multi-party lines, dormitory lines, and other lines to which the system would be unable to bill the collect call to (it may also include cellular phones and pay phones). If the BNS is not valid (i.e., to a telephone number that is restricted) the call is not placed 625.

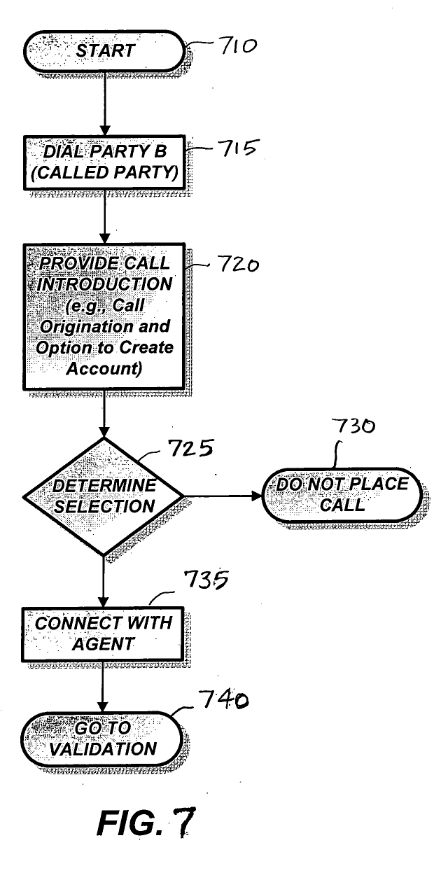

If the BNS is valid, the process performs 635 an operating company number (OCN) check to determine who owns the telephone, e.g., SBC, Verizon, etc., to which the call is being attempted. If the OCN check determines that the telephone is owned by a company that permits billing the collect call, the collect call is allowed and can be completed (or placed) 645. If the OCN check determines that telephone is owned by a company that does not permit billing the collect call, the telephone call is queued 640 outbound to the called party 140 (or the B-party) as further described with respect to FIG. 7. At this time, the call is not placed 625 (e.g., disconnected and/or reported as will not or cannot be connected).

It is noted for environments such as correctional facility, the company to whom the call is billable (or not billable) may be a call processing platform provider or a phone company. However, the company to whom the call is billable (or not billable) to could be a firm that has a contract with the facility to handle call-related operations, which may not necessarily be a call processing platform provider or a phone company.

FIG. 7 is a flow chart that illustrates one embodiment of a prepaid account set up in response to queue outbound call processing in accordance with the present invention. The process starts 710 with the system dialing the telephone number of the called party 140. In one embodiment, the call to the called party 140 is made without the calling party being made aware of the call. Further, in another embodiment, the calling party call may be disconnected at this point.

The process then provides a call introduction to the called party 140. The call introduction may include information on the call origination and option to create an account. In one embodiment, the call introduction may be a call greeting, for example, “An [inmate] at the Jones Correctional Facility is attempting to call you. If you would like to set up a prepaid calling account for [inmate] please press 1.” Next, the process determines whether the called party 140 has made a selection on how to proceed. If the called party 140 hangs up or otherwise elects not to proceed the call is not placed 730 and the system returns to an initial state relative to the calling and called parties (e.g., as described in FIG. 2).

If the called party 140 selects an option to create a prepaid account, the system forwards the call to a live agent that can help create (establish) a prepaid account for the called party. Creating the account may include obtaining payment related information, for example, bank routing numbers for direct bank withdrawal, credit card number for credit card payments, or online payment service information such as services offered by PayPal®, as well as verification information on such sensitive information. Once the account is created the system returns to an initial state (e.g., validation 740) relative to the calling and called parties (e.g., as described in FIG. 2). The next time the calling party places a collect call to the called party 140, the call is processed through the prepaid switch (subsystem) and switched from a collect call to prepaid call in real-time as described above.

It is noted that in an alternative embodiment, rather than connect with a live agent, the process can be configured to allow for creating a prepaid account using an automated system. For example, the automated system may be a prompting system that allows a user to navigate menus through their telephone to provide appropriate information to complete an application for and create a prepaid account. Once created, the system may be configured to switch the collect call to a prepaid call to immediately connect the calling party and the called party. In yet another embodiment, the prepaid account may be created through a secured online transaction, e.g., through a web browser interfacing with the prepaid switch 130 to complete an application for a prepaid account and creating the account within the system.

It is noted that the system and method described herein may be configured for operation and execution in hardware, firmware, software, or a combination thereof. For example, the system and method disclosed may be embodied through software program instructions that are executable by a processor, controller, or state machine. Moreover, such instructions may be stored on a computer readable medium such as a memory device (e.g., random access memory, read only memory, programmable read only memory, etc.), a magnetic disk drive (e.g., a hard disk drive or drum), an optical disk (e.g., a compact disc or DVD disc), a flash drive (e.g., a universal serial bus flash drive etc.), a flash storage medium (e.g., a CompactFlash card, SecureDigital card, a memory stick, etc.), or a floppy disk.

In addition, the system and method disclosed herein can be applied to communication mediums in addition to PSTN. For example, the principles disclosed herein may also be applied to voice over net telephone communications where the communication medium may include wide area networks, for example, the Internet, Internet2 or the like.

Advantages of the present invention include the ability for those that are with telephone companies that there is no billing agreement with to receive phone calls from those in a restricted calling facility (e.g., correctional facility or prison) without the calling party needing to know how to dial the call. The automatic attempts to setup the calls work both to assist the calling party (e.g., inmate) in placing a call and increasing revenue opportunities for the company offering calling services. Because the subsystem (or platform) is handling the “switch” and the call is not just being redirected allows the facility to retain control over the calls made by the calling party (e.g., inmates) and have accurate call detail records (CDR's) for reporting activity (e.g., investigations).

Upon reading this disclosure, those of skill in the art will appreciate still additional alternative structural and functional designs for a system and a process for switching call types (e.g., from a collect call type to a prepaid call type) in real-time, as well as configuring a prepaid calling system, through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

1. A method of establishing a telephone connection between a first party and a second party, the method comprising:
receiving a request to validate a collect call from a first party to a telephone number associated with the second party;
determining whether the collect call is permitted to the telephone number;
determining whether a pre-established account exists to debit against the collect call to the telephone number;
in response to the pre-established account existing, switching the collect call to a prepaid platform;
in response to the pre-established account not existing or the pre-established account having insufficient credit to debit against the call, placing an inquiry call to the second party;
in response to the inquiry call, creating for the second party a prepaid account to debit against collect calls.

2. The method of claim 1, wherein the step of determining whether the collect call is permitted further comprises:
determining, in response to the collect call being permitted, whether the collect call is direct billable;
determining, in response to the collect call being direct billable, whether a credit is available; and
placing the collect call to the second party in response to the credit being available.

3. The method of claim 1, wherein the switching to the prepaid platform further comprises identifying the collect call as a prepaid call.

4. The method of claim 3, wherein the switching to the prepaid platform further comprises:
receiving an account number;
receiving the telephone number; and
verifying availability of credit in the account.

5. The method of claim 4, wherein the switching to the prepaid platform further comprises:
connecting the call in response to credit being verified as available; and
disconnecting the call in response to credit being verified as unavailable.

6. A system for switching a call from a first subsystem to a second subsystem, the system comprising:
a call processing platform configured to receive a request for placing a collect call to a telephone number;
a validation engine, communicatively coupled with the call processing platform, configured to determine whether the collect call is connectable with the telephone number and configured to switch the collect call to a prepaid call in response to a prepaid account associated with the telephone number; and
a prepaid switch, communicatively coupled with the call processing platform, configured to receive the telephone number and an account identifier associated with the prepaid account and configured to connect the prepaid call with the telephone number in response to identifying the prepaid account.

7. The system of claim 6, wherein the prepaid switch is further configured to determine a balance in the prepaid account.

8. The system of claim 7, wherein the prepaid switch is further configured to connect the prepaid call with the telephone number in response to credit available in the prepaid account.

9. The system of claim 7, wherein the prepaid switch is further configured to not connect the prepaid call with the telephone number in response to insufficient credit in the prepaid account.

10. A computer readable medium configured to store computer readable program instructions executable by a processor, the instructions comprising:
receiving a request to validate a collect call from a first party to a telephone number associated with the second party;
determining whether the collect call is permitted to the telephone number;
determining whether a pre-established account exists to debit against the collect call to the telephone number;
in response to the pre-established account existing, switching the collect call to a prepaid platform;
in response to the pre-established account not existing or the pre-established account having insufficient credit to debit against the call, placing an inquiry call to the second party;
in response to the inquiry call, creating for the second party a prepaid account to debit against collect calls.

11. The computer readable medium of claim 10, wherein the instructions further comprise:
receiving an account number;
receiving the telephone number; and
verifying availability of credit in the account.

12. The computer readable medium of claim 10, wherein the instructions further comprise:
connecting the call in response to credit being verified as available; and
disconnecting the call in response to credit being verified as unavailable
